(19) United States
(12) Patent Application Publication
(10) Pub. No.: US 2026/0303310 A1
(43) Pub. Date: Oct. 1, 2026

(54) MULTIPLE PHYSICAL DOWNLINK SHARED CHANNEL COMMUNICATIONS IN SUBBAND FULL-DUPLEX

(71) Applicant: QUALCOMM Incorporated, San Diego, CA (US)

(72) Inventors: Mohammed JABI, San Diego, CA (US); Muhammad Sayed Khairy ABDELGHAFFAR, San Jose, CA (US); Qian ZHANG, Basking Ridge, NJ (US)

(21) Appl. No.: 19/432,087

(22) Filed: Dec. 23, 2025

Related U.S. Application Data
(60) Provisional application No. 63/777,519, filed on Mar. 25, 2025.

(51) Int. Cl. H04L 5/14; H04L 1/1812; H04W 72/232

(52) U.S. Cl. CPC H04L 5/14; H04L 1/1812; H04W 72/232

(57) ABSTRACT

Certain aspects of the present disclosure provide techniques for wireless communications. An example method includes receiving a subband full-duplex (SBFD) configuration that indicates whether communications of the UE are restricted with respect to SBFD symbols or non-SBFD symbols; receiving a downlink control information (DCI) communication scheduling multiple physical downlink shared channel (PDSCH) communications, wherein the DCI communication indicates a hybrid automatic repeat request (HARQ) process identifier; identifying a PDSCH communication, of the multiple PDSCH communications, to which the HARQ process identifier applies, wherein the PDSCH communication is identified based at least in part on the SBFD configuration and a symbol type in a reception occasion for the PDSCH communication; receiving the PDSCH communication in the reception occasion; and incrementing the HARQ process identifier based at least in part on receiving the PDSCH communication.

### RELATED APPLICATION

The present Application for Patent claims benefit of U.S. Provisional Application No. 63/777,519, filed Mar. 25, 2025, which is hereby expressly incorporated by reference herein in its entirety.

### INTRODUCTION

### Field of the Disclosure

Aspects of the present disclosure relate to wireless communications, and more particularly, to techniques for multiple physical downlink shared channel (PDSCH) communications in subband full-duplex (SBFD).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communications by a user equipment (UE). The method includes receiving a subband full-duplex (SBFD) configuration that indicates whether communications of the UE are restricted with respect to SBFD symbols or non-SBFD symbols; receiving a downlink control information (DCI) communication scheduling multiple physical downlink shared channel (PDSCH) communications, wherein the DCI communication indicates a hybrid automatic repeat request (HARQ) process identifier; identifying a PDSCH communication, of the multiple PDSCH communications, to which the HARQ process identifier applies, wherein the PDSCH communication is identified based at least in part on the SBFD configuration and a symbol type in a reception occasion for the PDSCH communication; receiving the PDSCH communication in the reception occasion; and incrementing the HARQ process identifier based at least in part on receiving the PDSCH communication.

Certain aspects provide a method of wireless communications by a UE. The method includes receiving an SBFD configuration that indicates whether communications of the UE are restricted with respect to SBFD symbols or non-SBFD symbols; receiving a DCI communication scheduling multiple PDSCH communications; associating multiple sets of time-domain resources, associated with the multiple PDSCH communications and indicated in the DCI, with a time domain allocation configuration in which at least one row includes multiple start and length indicator values (SLIVs) for PDSCH; and performing a PDSCH communication, of the multiple PDSCH communications based at least in part on the SBFD configuration and the time domain allocation configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A-4D depict various example aspects of data structures for a wireless communications network.

FIGS. 5A-5C depict example configurations for full-duplex communications in accordance with aspects of the present disclosure.

FIGS. 6A-6C depict examples of interference scenarios based on full-duplex communications.

FIGS. 7A-7B depict examples associated with configurations for subband full-duplex (SBFD) operation in accordance with aspects of the present disclosure.

FIG. 8 depicts a process flow for communications in a network between a UE and a network entity.

FIG. 9 depicts a process flow for communications in a network between a UE and a network entity.

FIG. 10 depicts a method for wireless communications.

FIG. 11 depicts aspects of an example communications device.

FIG. 12 depicts another method for wireless communications.

FIG. 13 depicts aspects of an example communications device.

### DETAILED DESCRIPTION

Aspects of the present disclosure provide apparatuses, methods, processing systems, and computer-readable mediums for multiple PDSCH communications in SBFD.

A wireless communications system may support subband full-duplex (SBFD) communications, which may also be referred to as “subband frequency division duplex (SBFDD)” or “flexible duplex.” In SBFD, a UE may transmit an uplink communication to a network entity in an uplink resource allocation and receive a downlink communication from the network entity in a downlink resource allocation at the same time, but on different frequency resources. Additionally, or alternatively, in SBFD, the network entity may transmit a downlink communication to the UE in the downlink resource allocation and receive an uplink communication from the UE or another UE in the uplink resource allocation at the same time, but on different frequency resources. For example, the different frequency resources may be subbands of a frequency band, such as a TDD band. In this case, the frequency resources used for the downlink resource allocation may be separated from the frequency resources used for the uplink resource allocation, in the frequency domain, by a guard band. In some examples, with respect to communications (e.g., uplink transmissions or downlink receptions) across SBFD symbols and non-SBFD symbols in different slots, a UE may be configured with a first configuration (referred to as Configuration 1) or a second configuration (referred to as Configuration 2). According to Configuration 1, communications are restricted to SBFD symbols only or non-SBFD symbols only (e.g., either to SBFD symbols or to non-SBFD symbols). That is, in Configuration 1, associated communications (e.g., all periodic transmissions/receptions associated with a given configuration) among a group of slots need to collectively occur entirely within SBFD symbols or entirely within non-SBFD symbols. According to Configuration 2, communications are permitted in SBFD symbols and/or in non-SBFD symbols. That is, in Configuration 2, associated communications among a group of slots can collectively occur within SBFD symbols and/or within non-SBFD symbols. In general, an SBFD-aware UE may be configured with Configuration 1 or Configuration 2 for a given BWP. An SBFD-aware UE is a UE that is capable of interpreting SBFD-related signaling, such as an indication of which resources are configured as SBFD resources. An SBFD-aware UE may or may not be capable of SBFD communication. An SBFD-capable UE is capable of SBFD communication (that is, concurrent uplink and downlink communication on uplink and downlink subbands).

Further, in some wireless communications systems, a UE can be scheduled with multiple physical downlink shared channel (PDSCH) communications by a single item of downlink control information (DCI). For example, according to an applicable wireless communications standard, upon detecting a physical downlink control channel (PDCCH) communication with a configured DCI format (e.g., DCI 1_0, 1_1, 1_2, 1_3, 4_0, 4_1, or 4_2), the UE may decode PDSCH communication(s) scheduled by the DCI. If the DCI schedules multiple PDSCH communications on a serving cell, then the UE may be configured to apply a hybrid automatic repeat request (HARQ) process identifier (ID) indicated in the DCI to a first of the multiple PDSCH communications that does not overlap with a configured uplink symbol (e.g., as indicated by a tdd-UL-DL-ConfigurationCommon or by a tdd-UL-DL-ConfigurationDedicated). Further, the UE may be configured to increment the HARQ process ID by 1 for each subsequent PDSCH communication in the scheduled order. Conversely, the UE may be configured to refrain from incrementing the HARQ process ID for a given PDSCH communication that is not received if at least one symbol indicated by an indexed row of a resource allocation table associated with a slot of the given PDSCH communication overlaps with a configured uplink symbol (e.g., as indicated by a tdd-UL-DL-ConfigurationCommon or by a tdd-UL-DL-ConfigurationDedicated). Further, the UE may be configured to not expect to be scheduled with PDSCH communications by a single DCI having format 1_1, where each PDSCH communication overlaps with a configured uplink symbol (e.g., as indicated by a tdd-UL-DL-ConfigurationCommon or by a tdd-UL-DL-ConfigurationDedicated). Thus, some UE procedures associated with multiple PDSCH communications scheduled by a single DCI may exclude one or more symbol types (e.g., uplink symbols). However, whether a UE is configured with Configuration 1 or Configuration 2 for communications across different slots is not considered with respect to the restrictions imposed on multiple PDSCH communications scheduled by a single DCI.

Technical problems with respect to multiple PDSCH communications scheduled by a single DCI in SBFD operation may include, for example, a lack of consideration with respect to whether a given UE is configured with Configuration 1 or Configuration 2 for SBFD communications across different slots. This lack of consideration can result in, for example, decreased reliability with respect to HARQ process ID incrementing, decreased reliability with respect to communication of multiple PDSCH communications scheduled by a single DCI having a particular format (e.g., format 1_1), or, more generally, to decreased reliability with respect to PDSCH communications scheduled using a single DCI in the context of SBFD operation. For example, this lack of consideration can lead to a difference in understanding, between the UE and the network, of which HARQ process IDs are assigned to certain PDSCHs, leading to a failure of HARQ feedback.

Aspects described herein may overcome the aforementioned technical problems, for example, by providing procedures with respect to multiple PDSCH communications scheduled by a single DCI in SBFD. In some aspects, a UE may receive an SBFD configuration that indicates whether communications of the UE are restricted with respect to SBFD symbols or non-SBFD symbols (e.g., an SBFD configuration that indicates whether to use Configuration 1 or Configuration 2), and may receive a DCI communication scheduling multiple PDSCH communications and indicating a HARQ process ID. In some aspects, the UE may identify a PDSCH communication, of the multiple PDSCH communications, to which the HARQ process identifier applies based at least in part on the SBFD configuration and a symbol type (e.g., uplink, downlink, flexible, SBFD) in a reception occasion for the PDSCH communication. The UE may then receive the PDSCH communication in the reception occasion and increment the HARQ process identifier accordingly.

Further, in some aspects, a UE may receive an SBFD configuration that indicates whether communications of the UE are restricted with respect to SBFD symbols or non-SBFD symbols, and may receive a DCI communication scheduling multiple PDSCH communications. The UE may further associate multiple sets of time-domain resources, associated with the multiple PDSCH communications and indicated in the DCI, with a time domain allocation configuration in which at least one row includes multiple start and length indicator values (SLIVs) for PDSCH. In some aspects, the UE may then perform a PDSCH communication (e.g., receive the PDSCH communication), of the multiple PDSCH communications, based at least in part on the SBFD configuration and the time domain allocation configuration. For example, when the SBFD configuration indicates Configuration 1 and a first (e.g., earliest) reception occasion indicated by the multiple SLIVs includes an SBFD symbol, the UE may not expect other PDSCHs to overlap with non-SBFD symbols. As another example, when the SBFD configuration indicates Configuration 1 and a first (e.g., earliest) reception occasion indicated by the multiple SLIVs includes a non-SBFD symbol, the UE may not expect other PDSCHs to overlap with SBFD symbols. As another example, when the SBFD configuration indicates Configuration 2, the UE may not expect PDSCHs to overlap with uplink symbols.

Certain techniques for multiple PDSCH communications in SBFD described herein may provide various beneficial technical effects and/or advantages. The techniques for multiple PDSCH communications in SBFD may enable improved wireless communications performance, such as increased reliability with respect to HARQ process ID incrementing, communication of multiple PDSCH communications scheduled by a single DCI having a particular format (e.g., format 1_1), or, more generally, PDSCH communications scheduled using a single DCI in the context of SBFD operation. This improved wireless communication performance may be attributable to the techniques and apparatuses for multiple PDSCH communications in SBFD described herein, for example, due to providing consideration of whether a given UE is configured with Configuration 1 or Configuration 2 for SBFD communications across different slots with respect to multiple PDSCH communications scheduled by a single DCI.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

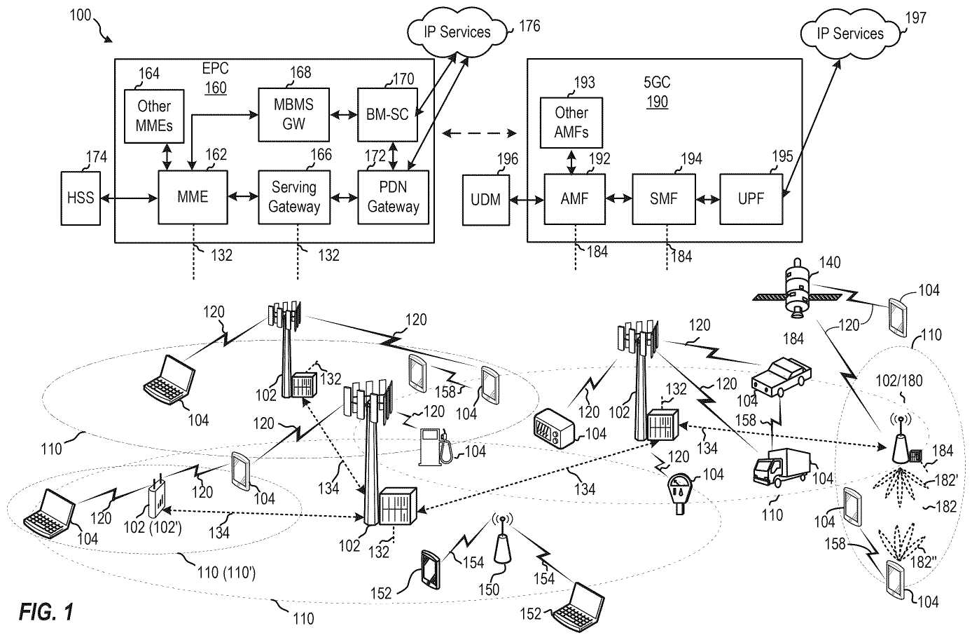

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

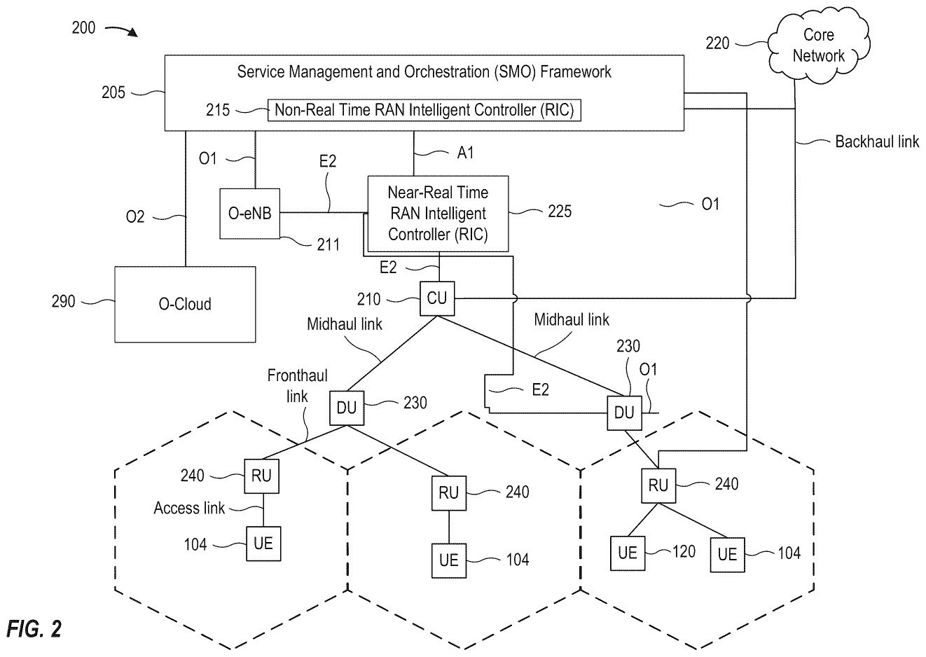

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

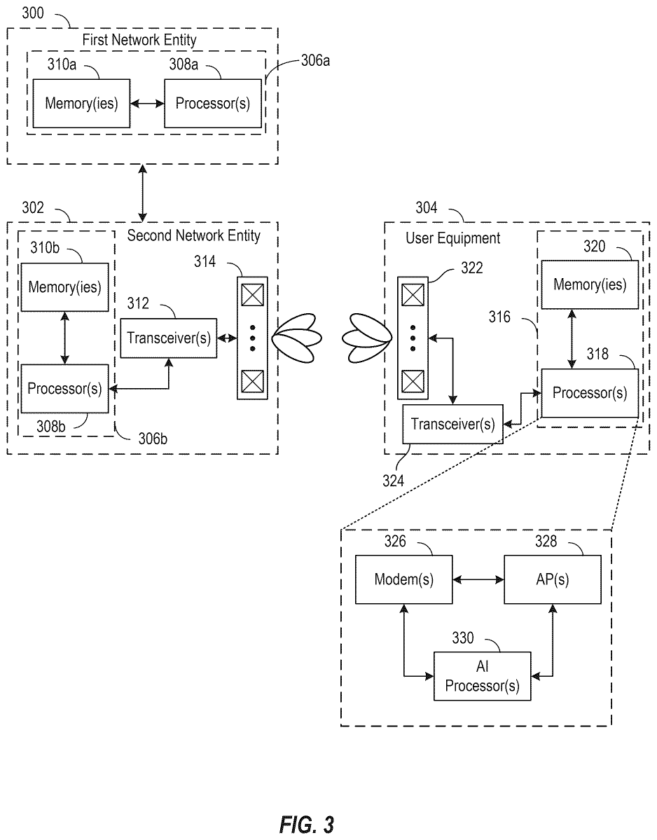

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

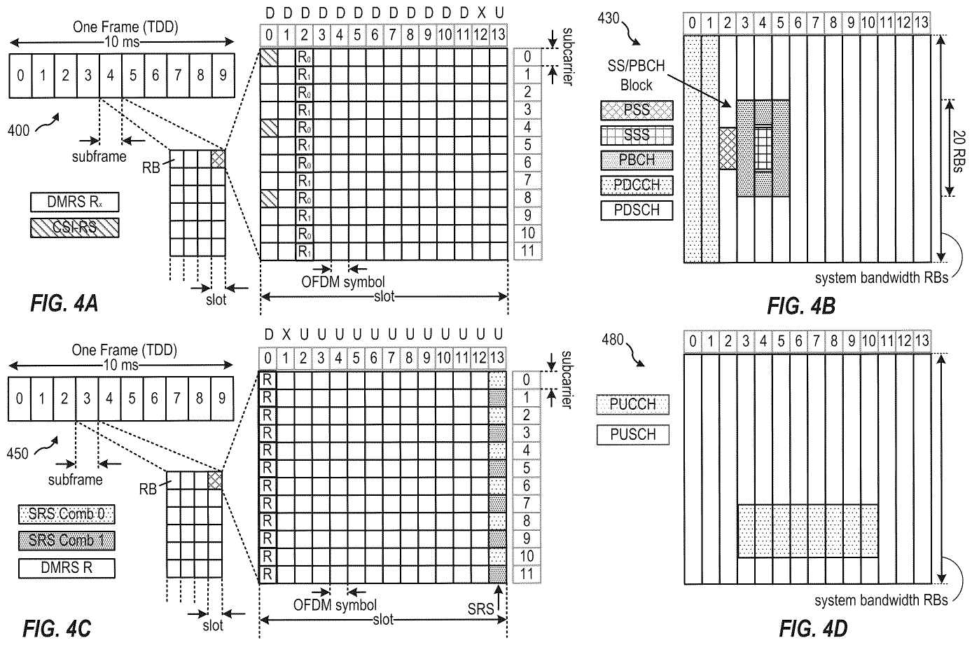

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Multiple PDSCH Communications in SBFD

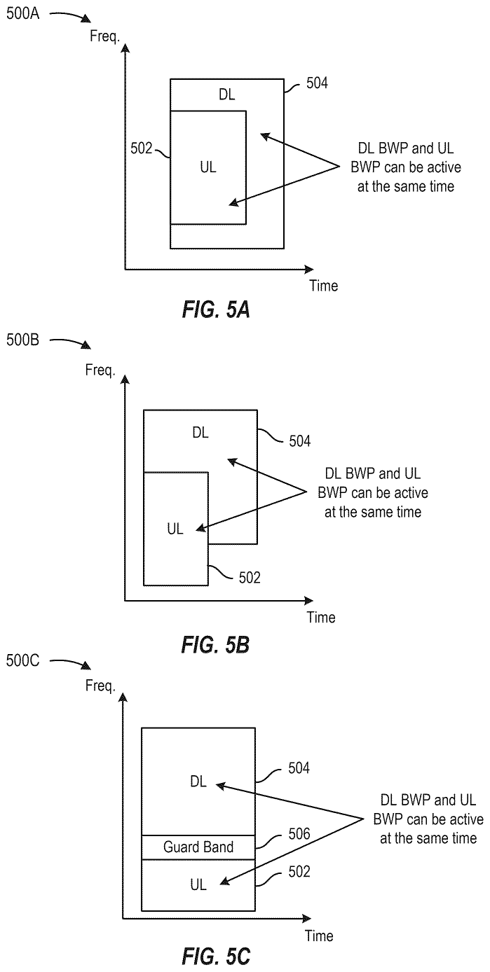

FIGS. 5A, 5B, and 5C depict example configurations for full-duplex communications in accordance with aspects of the present disclosure. For example, FIG. 5A depicts a first configuration 500A for full-duplex communications, FIG. 5B depicts a second configuration 500B for full-duplex communications, and FIG. 5C depicts a third configuration 500C for full-duplex communications. In some aspects, the first configuration 500A, the second configuration 500B, and the third configuration 500C may implement aspects of or may be implemented by aspects of FIGS. 1-4D. For example, a network entity or a UE may use the first configuration 500A, the second configuration 500B, or the third configuration 500C for full-duplex communications. In some aspects, the network entity may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of the UE 104 depicted and described with respect to FIG. 1 or the UE 304 depicted and described with respect to FIG. 3. Additionally, the first configuration 500A, the second configuration 500B, and the third configuration 500C may include aspects of the data structures for a wireless communications network depicted and described with respect to FIGS. 4A-4D.

As used herein, full-duplex communications in a wireless network refers to simultaneous bi-directional communication between devices in the wireless network. For example, a UE operating in a full-duplex mode may transmit an UL communication in an UL resource allocation 502 (e.g., an UL bandwidth part (BWP)) and receive a DL communication in a DL resource allocation 504 (e.g., a DL BWP) at the same time (e.g., in the same slot or the same symbol), and/or a network entity operating in a full-duplex mode may receive an UL communication in the UL resource allocation 502 and transmit a DL communication in the DL resource allocation 504 at the same time. Alternatively, half-duplex communications in a wireless network refers to unidirectional communications (e.g., only DL communication or only UL communication) between devices at a given time (e.g., in a given slot or a given symbol).

As shown in FIGS. 5A and 5B, the first configuration 500A and the second configuration 500B show examples of in-band full-duplex (IBFD) communication. In IBFD, the UE may transmit an UL communication to a network entity in the UL resource allocation 502 and receive a DL communication from the network entity in the DL resource allocation 504 on one or more same time and frequency resources, or the network entity may transmit a DL communication to a UE in the DL resource allocation 504 and receive an UL communication from the UE in the UL resource allocation 502 on one or more same time and frequency resources. As shown in the first configuration 500A, in a first example of IBFD, time and frequency resources for the UL resource allocation 502 may fully overlap with time and frequency resources for the DL resource allocation 504. As shown in the second configuration 500B, in a second example of IBFD, time and frequency resources for the UL resource allocation 502 may partially overlap with time and frequency resources for the DL resource allocation 504.

As further shown in FIG. 5C, the third configuration 500C shows an example of subband full-duplex (SBFD) communications, which may also be referred to as “subband frequency division duplex (SBFDD)” or “flexible duplex.” In SBFD, the UE may transmit an UL communication to a network entity in the UL resource allocation 502 and receive a DL communication from the network entity in the DL resource allocation 504 at the same time, but on different frequency resources. Additionally or alternatively, in SBFD, the network entity may transmit a DL communication to a UE in the DL resource allocation 504 and receive an UL communication from the UE in the UL resource allocation 502 at the same time, but on different frequency resources. For example, the different frequency resources may be subbands of a frequency band, such as a TDD band. In this case, the frequency resources used for the DL resource allocation 504 may be separated from the frequency resources used for the UL resource allocation 502, in the frequency domain, by a guard band 506.

SBFD may increase an UL duty cycle, improve UL coverage, and reduce latency, because it is possible to transmit an UL signal in an UL subband in DL only or in flexible slots. SBFD may enhance system capacity, resource utilization, and spectrum efficiency. SBFD may enable flexible and dynamic UL and DL resource adaption according to UL and DL traffic in a robust manner. If random access is allowed in SBFD symbols for SBFD-aware UEs (UEs capable of supporting SBFD operation), it may potentially reduce the random access latency, reduce the PRACH collision probability, and/or improve the coverage of PRACH and messages for a RACH procedure. A random access channel (RACH) configuration may indicate a quantity of synchronization signal blocks (SSBs) per RACH occasion (RO) and power information for PRACH messages (e.g., preambles).

As indicated above, FIGS. 5A, 5B, and 5C are provided as examples. Other examples may differ from what is described with respect to FIGS. 5A, 5B, and 5C.

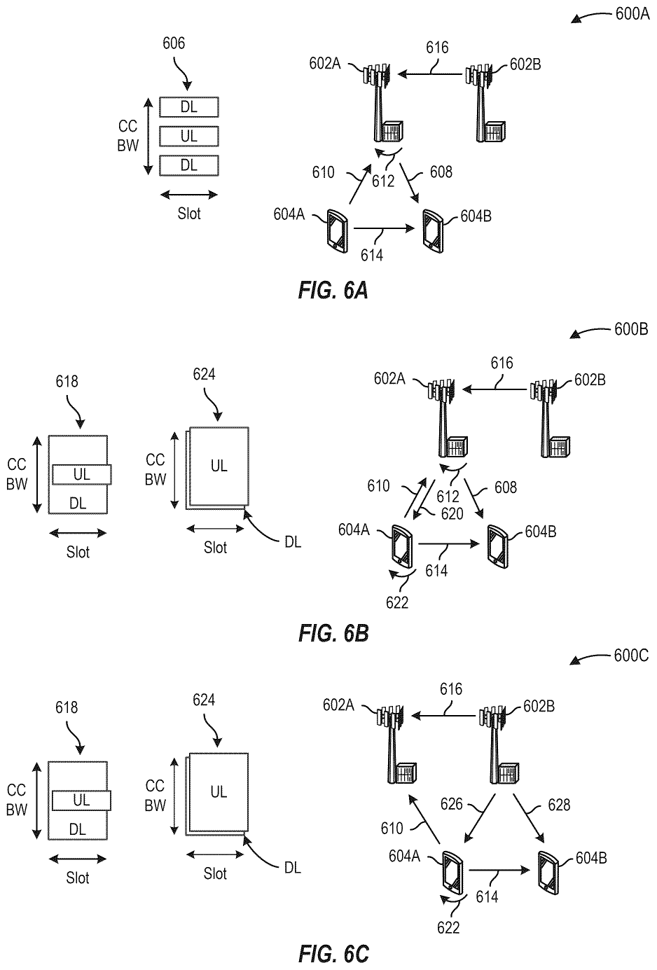

FIGS. 6A, 6B, and 6C depict examples of interference scenarios based on full-duplex communications. For example, FIG. 6A depicts a first interference scenario 600A based on full-duplex communications, FIG. 6B depicts a second interference scenario 600B based on full-duplex communications, and FIG. 6C depicts a third interference scenario 600C based on full-duplex communications.

In some aspects, the first interference scenario 600A, the second interference scenario 600B, and the third interference scenario 600C may implement aspects of or may be implemented by aspects of FIGS. 1-5C. For example, the first interference scenario 600A, the second interference scenario 600B, and the third interference scenario 600C may include a first network entity 602A, a second network entity 602B, a first UE 604A, and a second UE 604B. In some aspects, the first network entity 602A and the second network entity 602B may be examples of the BS 102 depicted and described with respect to FIG. 1, the first network entity 300 or the second network entity 302 depicted and described with respect to FIG. 3, a disaggregated base station depicted and described with respect to FIG. 2, or the network entity described with respect to FIGS. 5A-5C. Similarly, the first UE 604A and the second UE 604B may be examples of the UE 104 depicted and described with respect to FIG. 1, the UE 304 depicted and described with respect to FIG. 3, or the UE described with respect to FIGS. 5A-5C. Additionally, the first interference scenario 600A, the second interference scenario 600B, and the third interference scenario 600C may include aspects of the data structures for a wireless communications network depicted and described with respect to FIGS. 4A-4D. FIGS. 6A, 6B, and 6C are provided as examples. Other examples of interference scenarios may differ from what is described with respect to FIGS. 6A, 6B, and 6C.

In the first interference scenario 600A depicted in the example of FIG. 6A, the first network entity 602A (e.g., a full-duplex gNB) may use an SBFD communication 606 (e.g., the SBFD communications depicted and described with respect to FIG. 5C) to concurrently communicate with the first UE 604A (e.g., a half-duplex UE) and the second UE 604B (e.g., a half-duplex UE). For example, the first network entity 602A may send a DL transmission 608 to the second UE 604B at the same time that the first UE 604A sends an UL transmission 610 to the first network entity 602A. In the first interference scenario 600A, the DL transmission 608 may result in a network entity self-interference 612 at the first network entity 602A when the first network entity 602A is attempting to decode the UL transmission 610. In some aspects, the UL transmission 610 may result in an inter-UE CLI 614 (e.g., an intra-cell UE-to-UE CLI) at the second UE 604B when the second UE 604B is attempting to decode the DL transmission 608.

Additionally, in the first interference scenario 600A depicted in the example of FIG. 6A, the second network entity 602B (e.g., a full-duplex gNB) may transmit a DL transmission to an additional UE (not shown) at the same time that the first UE 604A transmits the UL transmission 610 to the first network entity 602A. Accordingly, the DL transmission by the second network entity 602B may result in an inter-network entity CLI 616 (e.g., inter-gNB CLI) at the first network entity 602A when the first network entity 602A is attempting to decode the UL transmission 610.

In the second interference scenario 600B depicted in the example of FIG. 6B, the first network entity 602A (e.g., a full-duplex gNB) may concurrently use a full-duplex communication 618 (e.g., the partially-overlapping IBFD communications depicted and described with respect to FIG. 5A) or a full-duplex configuration 624 (e.g., the full-overlapping IBFD communications depicted and described with respect to FIG. 5B) to communicate with the first UE 604A (e.g., a full-duplex UE) and half-duplex communication to communicate with the second UE 604B (e.g., a half-duplex UE). For example, the first network entity 602A may transmit the DL transmission 608 to the second UE 604B at the same time that the first UE 604A transmits the UL transmission 610 to the first network entity 602A. At the same time, the first network entity 602A may transmit a DL transmission 620 to the first UE 604A. Accordingly, the DL transmission 608 or the DL transmission 620 may result in the network entity self-interference 612 at the first network entity 602A when the first network entity 602A is attempting to decode the UL transmission 610. In some aspects, the UL transmission 610 may result in a UE self-interference 622 at the first UE 604A when the first UE 604A is attempting to decode the DL transmission 620. Additionally, the UL transmission 610 may result in the inter-UE CLI 614 at the second UE 604B when the second UE 604B is attempting to decode the DL transmission 608. In some aspects, a DL transmission by the second network entity 602B may also result in the inter-network entity CLI 616 at the first network entity 602A when the first network entity 602A is attempting to decode the UL transmission 610.

In the third interference scenario 600C depicted in the example of FIG. 6C, the second network entity 602B may communicate with the first UE 604A (e.g., a full-duplex UE) and the second UE 604B (e.g., a half-duplex UE), where the first UE 604A uses the full-duplex communication 618 or the full-duplex configuration 624. As shown, the second network entity 602B may transmit a DL transmission 626 to the first UE 604A at the same time as transmitting a DL transmission 628 to the second UE 604B. At the same time, the first UE 604A may transmit the UL transmission 610 to the first network entity 602A. Accordingly, the UL transmission 610 may result in the UE self-interference 622 at the first UE 604A when the first UE 604A is attempting to decode the DL transmission 626. Additionally, the UL transmission 610 may result in the inter-UE CLI 614 at the second UE 604B when the second UE 604B is attempting to decode the DL transmission 628. In some aspects, the DL transmission 626 or the DL transmission 628 may result in the inter-network entity CLI 616 at the first network entity 602A when the first network entity 602A is attempting to decode the UL transmission 610. In some aspects, the first network entity 602A and the second network entity 602B may be different transmission and reception points (TRPs) of a same network entity, where the same network entity is a multi-TRP entity.

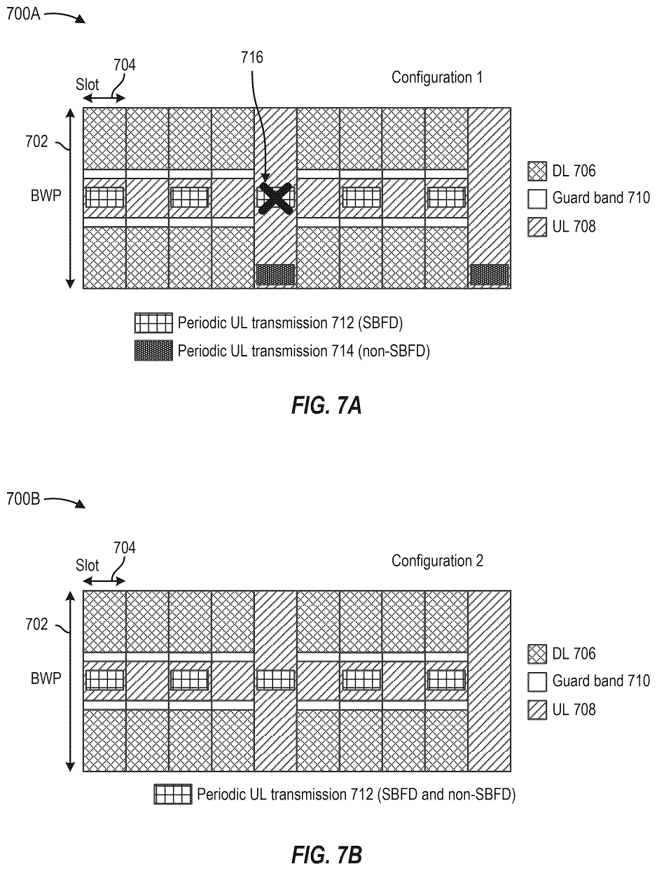

FIGS. 7A and 7B depict examples associated with configurations for SBFD operation in accordance with aspects of the present disclosure. For example, FIG. 7A depicts an example 700A associated with a first configuration for SBFD operation and FIG. 7B depicts an example 700B associated with a second configuration for SBFD operation. In some aspects, the first example 700A or the second example 700B may implement aspects of or may be implemented by aspects of FIGS. 1-6C. For example, in the example 700A, a UE may be configured with a first configuration (e.g., Configuration 1) for SBFD operation, as described below. Similarly, in the example 700B, the UE may be configured with a second configuration (e.g., Configuration 2) for SBFD operation, as described below. In some aspects, the UE may be an example of the UE 104 depicted and described with respect to FIG. 1 or the UE 304 depicted and described with respect to FIG. 3.

In some aspects, for communications (e.g., uplink transmissions or downlink receptions) across SBFD symbols and non-SBFD symbols in different slots (e.g., such that each transmission or reception within a given slot has either all SBFD or all non-SBFD symbols) the UE (e.g., an SBFD-aware UE) may be configured with a first configuration (e.g., Configuration 1, as indicated in FIG. 7A). According to the first configuration, communications may be restricted to SBFD symbols only or non-SBFD symbols only. The example 700A is illustrative of UE communications according to the first configuration. In the example 700A, a bandwidth part (BWP) 702 comprises a series of slots 704, where each slot 704 comprises a group of symbols such as OFDM symbols (not individually labeled). In the example 700A, a given slot 704 comprise either SBFD symbols (e.g., symbols including a pair of downlink resources 706 and an uplink resource 708 that are separated by guard bands 710, such as the first slot in the example 700A) or a group of non-SBFD symbols (e.g., symbols including an uplink resource 708 or a downlink resource only, such as the fifth slot in the example 700A). In some aspects, a non-SBFD symbol is a symbol that is configured as a downlink symbol, an uplink symbol, or a flexible symbol. In this example, the UE is configured with the first configuration (e.g., the configuration indicating that communications are restricted to SBFD symbols only or non-SBFD symbols only). Further, in the example 700A, the UE is configured with a periodic uplink transmission 712 (e.g., with a two-slot periodicity) and a periodic uplink transmission 714 (e.g., with a five-slot periodicity). Here, as indicated in the example 700A and in accordance with the first configuration, the UE may transmit the periodic uplink transmission 712 in SBFD symbols (e.g., the first, third, seventh, and ninth slots 704, which comprise SBFD symbols) and may refrain from transmitting the periodic uplink transmission 712 in non-SBFD symbols (e.g., the fifth slot, which comprises non-SBFD symbols), as indicated by reference 716. That is, according to the first configuration indicating that communications are restricted to SBFD symbols only or non-SBFD symbols only, the UE may transmit the periodic uplink transmission 712 in SBFD symbols only. For example, because the first transmission occasion for the periodic uplink transmission 712 is in a slot 704 comprising SBFD symbols, transmissions of the periodic uplink transmission 712 should occur in SBFD symbols only. Therefore, the UE refrains from transmitting the periodic uplink transmission 712 in slots 704 that do not include SBFD symbols only (e.g., the fifth slot 704). Additionally, as further indicated in the example 700A and in accordance with the first configuration, the UE may transmit the periodic uplink transmission 714 in non-SBFD symbols (e.g., the fifth and tenth slots 704, which comprise non-SBFD symbols). That is, according to the first configuration indicating that communications are restricted to SBFD symbols only or non-SBFD symbols only, the UE may transmit the periodic uplink transmission 714 in non-SBFD symbols only. For example, because the first transmission occasion for the periodic uplink transmission 714 is in a slot 704 comprising non-SBFD symbols, all transmissions of the periodic uplink transmission 714 should occur in non-SBFD symbols only.

Alternatively, in some aspects, for communications across SBFD symbols and non-SBFD symbols in different slots, the UE may be configured with a second configuration (e.g., Configuration 2, as indicated in FIG. 7B). According to the second configuration, communications may be in SBFD symbols and/or non-SBFD symbols. The example 700B is illustrative of UE communications according to the second configuration. In the example 700B, the BWP 702 comprises the series of slots 704 (similar to the BWP 702 depicted and described with respect to the example 700A). In this example, the UE is configured with the second configuration (e.g., the configuration indicating that may be in SBFD symbols and/or non-SBFD symbols). Further, in the example 700B, the UE is configured with a periodic uplink transmission 712 (e.g., with a two-slot periodicity). Here, as indicated in the example 700B and in accordance with the second configuration, the UE may transmit the periodic uplink transmission 712 in SBFD symbols (e.g., the first, third, seventh, and ninth slots, which comprise SBFD symbols) and non-SBFD symbols (e.g., the fifth slot, which comprises non-SBFD symbols) according to the two-slot periodicity. That is, according to the second configuration indicating that communications may be in SBFD symbols and/or non-SBFD symbols, the UE may transmit the periodic uplink transmission 712 in SBFD symbols and non-SBFD symbols.

In some examples, a UE may be configured with the second configuration on a per BWP 702 basis (e.g., per uplink BWP, per downlink BWP, or the like). In some aspects, such a configuration for a downlink BWP 702 may apply to at least PDSCH communication within the downlink BWP 702, while such a configuration for an uplink BWP 702 may apply to PUCCH communications and PUSCH communications within the UL BWP 702. In some examples, the first configuration may be applicable with respect to a sounding reference signal (SRS). In some example, the first configuration is a default capability, and support for the second configuration 2 is subject to UE capability.

### Example Signaling Associated with Multiple PDSCH Communications in SBFD

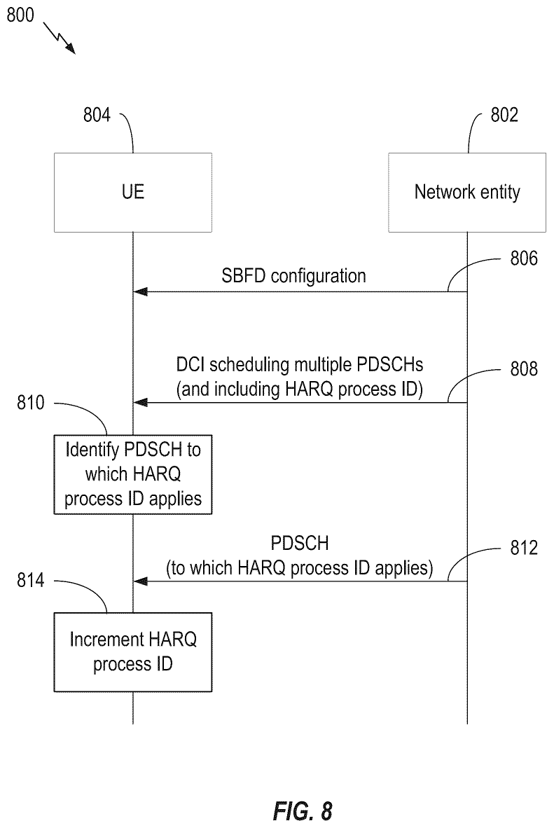

FIG. 8 depicts a process flow 800 for communications in a network between a network entity 802 and a UE 804. In some aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device and network entity 802 may be another type of network entity or network node, such as those described herein. Note that any operations or signaling illustrated with dashed lines may indicate that that operation or signaling is an optional or alternative example.

At 806, the UE 804 receives, from the network entity 802, an SBFD configuration that indicates whether communications of the UE 804 are restricted with respect to SBFD symbols or non-SBFD symbols. For example, the SBFD configuration may indicate that communications are restricted to SBFD symbols only or to non-SBFD symbols only (e.g., the SBFD configuration may be or indicate Configuration 1). In Configuration 1, associated communications (e.g., all periodic transmissions/receptions associated with a given configuration) among a group of slots need to collectively occur entirely within SBFD symbols or entirely within non-SBFD symbols. As another example, the SBFD configuration may indicate that communications are permitted in both SBFD symbols and non-SBFD symbols (e.g., the SBFD configuration may be or indicate Configuration 2). In Configuration 2, associated communications among a group of slots can collectively occur within SBFD symbols and/or within non-SBFD symbols.

In some aspects, the UE 804 may transmit, to the network entity 802, capability information indicating UE support for the SBFD configuration that indicates that communications are permitted in both SBFD symbols and non-SBFD symbols. For example, in some aspect the UE 804 may transmit capability information indicating whether the UE 804 supports Configuration 2. In some aspects, the SBFD configuration may be in accordance with the UE capability information (e.g., the UE 804 may be configured with Configuration 2 only if the UE 804 indicates support for Configuration 2).

At 808, the UE 804 receives a DCI communication scheduling multiple PDSCH communications. That is, the UE 804 may receive a PDCCH communication with a configured DCI format (e.g., DCI Format 1_0, 1_1, 1_2, 1_3, 4_0, 4_1, or 4_2 as defined, for example, in 3GPP Technical Specification 38.212) that schedules multiple PDSCH communications on a serving cell. For example, the DCI communication may include a plurality of time-domain resource allocations for the multiple PDSCH communications, which may indicate reception occasions for the multiple PDSCH communications. In some aspects, the DCI communication indicates a HARQ process ID.

At 810, the UE 804 identifies a PDSCH communication, of the multiple PDSCH communications, to which the HARQ process ID applies. In some aspects, the UE 804 may identify the PDSCH communication based at least in part on the SBFD configuration and a symbol type in a reception occasion for the PDSCH communication. A reception occasion is a time and/or frequency resource in which the PDSCH communication is scheduled or configured by the DCI communication.

In some examples, the SBFD configuration may indicate that communications are restricted to SBFD symbols only or to non-SBFD symbols only (e.g., the UE 804 may be configured with Configuration 1), and a first (e.g., in the time domain) reception occasion associated with the multiple PDSCH communications (e.g., a first-in-time reception occasion among reception occasions for the multiple PDSCH communications) may include one or more SBFD symbols. In some such examples, the UE 804 may identify the PDSCH communication to which the HARQ process ID applies as a first (e.g., in the time domain) PDSCH communication, of the multiple PDSCH communications, for which a reception occasion includes SBFD symbols. That is, in some examples, if the UE 804 is configured with Configuration 1 (e.g., for downlink transmission per downlink BWP), the UE 804 is scheduled with multiple PDSCH communications by a single DCI and a first reception occasion is in SBFD symbols, then the HARQ process ID indicated by the DCI applies to the first PDSCH communication in SBFD symbols. Similarly, in some such examples, the UE 804 may identify the PDSCH communication to which the HARQ process ID applies as a first PDSCH communication, of the multiple PDSCH communications, for which a reception occasion does not overlap with any non-SBFD symbol. That is, in some examples, if the UE 804 is configured with Configuration 1, the UE 804 is scheduled with multiple PDSCH communications by a single DCI, and a first reception occasion is in SBFD symbols, then the HARQ process ID indicated by the DCI applies to the first PDSCH communication not overlapping with non-SBFD symbols (e.g., downlink symbols, flexible symbols, or uplink symbols).

In some other examples, the SBFD configuration may indicate that communications are restricted to SBFD symbols only or to non-SBFD symbols only (e.g., the UE 804 may be configured with Configuration 1), and the first (e.g., in the time domain) reception occasion associated with the multiple PDSCH communications may include one or more non-SBFD symbols. In some such examples, the UE 804 may identify the PDSCH communication to which the HARQ process ID applies as a first PDSCH communication, of the multiple PDSCH communications, for which a reception occasion includes one or more downlink symbols or one or more flexible symbols. That is, in some examples, if the UE 804 is configured with Configuration 1, the UE 804 is scheduled with multiple PDSCH communications by a single DCI, and a first reception occasion is in non-SBFD symbols, then the HARQ process ID indicated by the DCI applies to the first PDSCH communication in downlink symbols or flexible symbols (e.g., non-SBFD symbols). Similarly, in some such examples, the UE 804 may identify the PDSCH communication to which the HARQ process ID applies as a first PDSCH communication, of the multiple PDSCH communications, for which a reception occasion does not overlap with any uplink symbol or any SBFD symbol. That is, in some examples, if the UE 804 is configured with Configuration 1, the UE 804 is scheduled with multiple PDSCH communications by a single DCI, and a first reception occasion is in non-SBFD symbols, then the HARQ process ID indicated by the DCI applies to the first PDSCH communication not overlapping with uplink symbols or SBFD symbols.

In some examples, the SBFD configuration may indicate that communications are permitted in both SBFD symbols and non-SBFD symbols (e.g., the UE 804 may be configured with Configuration 2). In some such examples, the UE 804 may identify the PDSCH communication to which the HARQ process ID applies as a first PDSCH communication, of the multiple PDSCH communications, for which a reception occasion includes a downlink symbol (e.g., one or more downlink symbols) or a flexible symbol (e.g., one or more flexible symbols). That is, in some examples, if the UE 804 is configured with Configuration 2 and the UE 804 is scheduled with multiple PDSCH communications by a single DCI, then the UE 804 HARQ process ID indicated by the DCI applies to the first PDSCH communication in downlink symbols or flexible symbols. Similarly, in some such examples, the UE 804 may identify the PDSCH communication to which the HARQ process ID applies as a first PDSCH communication, of the multiple PDSCH communications, for which a reception occasion includes an SBFD symbol. That is, in some examples, if the UE 804 is configured with Configuration 2 and the UE 804 is scheduled with multiple PDSCH communications by a single DCI, then the HARQ process ID indicated by the DCI applies to the first PDSCH communication in SBFD symbols. Similarly, in some such examples, the UE 804 may identify the PDSCH communication to which the HARQ process ID indicated by the DCI applies as a first PDSCH communication, of the multiple PDSCH communications, for which a reception occasion does not overlap with any uplink symbol. That is, in some examples, if the UE 804 is configured with Configuration 2 and the UE 804 is scheduled with multiple PDSCH communications by a single DCI, then the HARQ process ID indicated by the DCI applies to the first PDSCH communication not overlapping with uplink symbols.

At 812, the UE 804 receives the PDSCH communication (i.e., the PDSCH to which the HARQ process ID applies) in the reception occasion.

At 814, the UE 804 increments the HARQ process identifier based at least in part on receiving the PDSCH communication. That is, after receiving the PDSCH communication identified as the PDSCH communication to which the HARQ process ID applies, the UE 804 increments the HARQ process ID. “Incrementing the HARQ process ID” may refer to identifying a HARQ process ID for another scheduled PDSCH communication. For example, if the PDSCH communication at 814 is assigned HARQ process ID 1, the UE 804 may increment the HARQ process ID to HARQ process ID 2, and may identify another PDSCH communication (if any) to which HARQ process ID 2 applies. This may be relevant for structuring HARQ feedback about multiple HARQ processes, as described below.

In some aspects, the UE 804 may refrain from incrementing the HARQ process ID. That is, in some aspects, the HARQ process ID is not incremented.

For example, in some aspects, the SBFD configuration may indicate that communications are restricted to SBFD symbols only or to non-SBFD symbols only (e.g., the UE 804 may be configured with Configuration 1), and a first reception occasion associated with the multiple PDSCH communications may include one or more SBFD symbols. In some such examples, the UE 804 may refrain from incrementing the HARQ process identifier with respect to another PDSCH communication, of the multiple PDSCH communications, where a reception occasion for the other PDSCH communication includes one or more non-SBFD symbols. That is, the HARQ process ID is in some aspects not incremented for PDSCH communications not received in invalid symbol types (non-SBFD symbols in this example). Thus, since these PDSCH communications are not going to be received by the UE 804 in accordance with Configuration 1, the UE does not increment the HARQ process ID, and may instead use the HARQ process ID for a different PDSCH communication that will be received by the UE 804. Similarly, in some such examples, the UE 804 may refrain from incrementing the HARQ process ID with respect to another PDSCH communication, of the multiple PDSCH communications, based at least in part on a TDRA associated with the other PDSCH communication including at least one non-SBFD symbol. That is, the HARQ process ID is in some aspects not incremented for PDSCH communications for which at least one symbol indicated by the TDRA is a non-SBFD symbol (e.g., a downlink symbol, an uplink symbol, or a flexible symbol).

As another example, in some aspects, the SBFD configuration may indicate that communications are restricted to SBFD symbols only or to non-SBFD symbols only, and a first reception occasion associated with the multiple PDSCH communications may include one or more non-SBFD symbols. In some such examples, the UE 804 may refrain from incrementing the HARQ process ID with respect to another PDSCH communication, of the multiple PDSCH communications, where a reception occasion for the other PDSCH communication includes one or more SBFD symbols. That is, the HARQ process ID is in some aspects not incremented for PDSCH communications not received in invalid symbol types (SBFD symbols in this example). Thus, since these PDSCH communications are not going to be received by the UE 804 in accordance with Configuration 1, the UE does not increment the HARQ process ID, and may instead use the HARQ process ID for a different PDSCH communication that will be received by the UE 804. Similarly, in some such examples, the UE 804 may refrain from incrementing the HARQ process ID with respect to another PDSCH communication, of the multiple PDSCH communications, based at least in part on a TDRA associated with the other PDSCH communication including at least one SBFD symbol or at least one uplink symbol. That is, the HARQ process ID is in some aspects not incremented for PDSCH communications for which at least one symbol indicated by the TDRA is an SBFD symbol or an uplink symbol.

As another example, in some aspects, the SBFD configuration may indicate that communications are permitted in both SBFD symbols and non-SBFD symbols (e.g., the UE 804 may configured with Configuration 2). In some such examples, the UE 804 may refrain from incrementing the HARQ process ID with respect to another PDSCH communication, of the multiple PDSCH communications, based at least in part on a TDRA associated with the other PDSCH communication including at least one uplink symbol. That is, the HARQ process ID is in some aspects not incremented for PDSCH communications for which at least one symbol indicated by the TDRA is an uplink symbol. Thus, since these PDSCH communications include an uplink symbol and thus will not be received in accordance with Configuration 2, the UE 804 does not increment the HARQ process ID, and may instead use the HARQ process ID for a different PDSCH communication that will be received by the UE 804.

In some aspects, the UE 804 may transmit, the network entity 802, feedback information associated with at least one PDSCH communication of the multiple PDSCH communications. In some aspects, the feedback information may include an item of feedback (e.g., a HARQ acknowledgment (ACK) or HARQ negative ACK (NACK)) associated with the PDSCH communication to which the HARQ process ID applies. In some aspects, the feedback information may further include a second item of feedback associated with another PDSCH communication of the multiple PDSCH communications, where the other PDSCH communication is associated with the incremented HARQ process ID. In some aspects, the feedback information may associate a given item of feedback with a respective HARQ process ID (e.g., the HARQ process ID or an incremented HARQ process ID) so as to enable the network entity 802 to map items of feedback included in the feedback information to respective PDSCH communications of the multiple PDSCH communications. In some aspects, the network entity 802 may retransmit one or more PDSCH communications in accordance with the feedback information, such as one or more PDSCH communications for which the feedback information indicates a HARQ NACK.

Note that the process flow illustrated in FIG. 8 is an example associated with multiple PDSCH communications in SBFD, and aspects of the present disclosure may be applied to multiple PDSCH communications in SBFD. Note that the process flow illustrated in FIG. 8 is described herein to facilitate an understanding of multiple PDSCH communications in SBFD, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

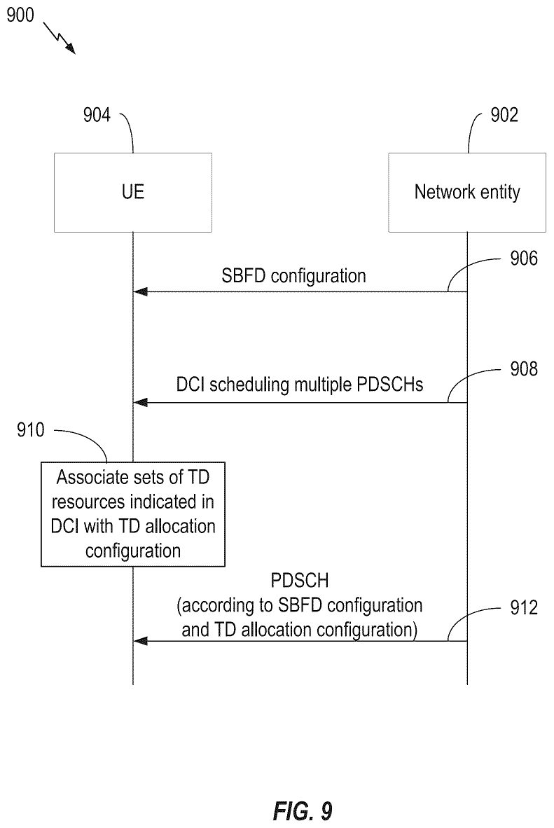

FIG. 9 depicts a process flow 900 for communications in a network between a network entity 902 and a UE 904. In some aspects, the network entity 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 904 may be an example of UE 104 depicted and described with respect to FIG. 1 or the UE 304 depicted and described with respect to FIG. 3. However, in other aspects, UE 904 may be another type of wireless communications device and network entity 902 may be another type of network entity or network node, such as those described herein. Note that any operations or signaling illustrated with dashed lines may indicate that that operation or signaling is an optional or alternative example.

At 906, the UE 904 receives, from the network entity 902, an SBFD configuration that indicates whether communications of the UE 904 are restricted with respect to SBFD symbols or non-SBFD symbols. For example, the SBFD configuration may indicate that communications are restricted to SBFD symbols only or to non-SBFD symbols only (e.g., the SBFD configuration may be Configuration 1). As another example, the SBFD configuration may indicate that communications are permitted in both SBFD symbols and non-SBFD symbols (e.g., the SBFD configuration may be Configuration 2).

At 908, the UE 904 receives a DCI communication scheduling multiple PDSCH communications. That is, the UE 904 may receive a PDCCH communication with a configured DCI format that schedules multiple PDSCH communications on a serving cell. In some aspects, a format of the DCI communication is a non-fallback downlink scheduling DCI format for one cell (e.g., DCI format 1_1).

In some aspects, the DCI may indicate multiple start and length indicator values (SLIVs). In some aspects, each of the multiple SLIVs indicates a set of time-domain resources for a respective one of the multiple PDSCH communications. A SLIV is a value that defines a starting symbol and number of symbols (e.g., consecutive symbols) for a PDSCH communication. Thus, a SLIV may indicate a set of time-domain resources for a PDSCH communication, where the set of time-domain resources starts at the starting symbol and includes the number of symbols.

At 910, the UE 904 associates the multiple sets of time-domain resources (e.g., SLIVs) indicated in the DCI with a time domain allocation configuration including a list of time-domain resources (e.g., SLIVs) for PDSCH transmission (e.g., an RRC configuration, such as pdschTime DomainAllocation ListForMultiPDSCH). In some aspects, the time domain allocation configuration is received by the UE 904 before the DCI communication scheduling the multiple PDSCH communications is received by the UE 904. In some aspects, to enable multiple PDSCH communications to be scheduled by a single DCI communication, the list of time-domain resources included in the time domain allocation configuration includes multiple rows, and each row may include multiple time-domain resources (e.g., SLIVs). Therefore, in some aspects, the DCI communication scheduling the multiple PDSCH communications may refer to the list of time-domain resources included in the time domain allocation configuration to indicate multiple sets of time-domain resources, each corresponding to a respective PDSCH communication of the multiple PDSCH communications.

At 912, the UE 904 performs a PDSCH communication, of the multiple PDSCH communications based at least in part on the SBFD configuration and the time domain allocation configuration. For example, the UE 904 may receive one of the PDSCH communications scheduled by the DCI based at least in part on the SBFD configuration (e.g., Configuration 1 or Configuration 2) and the time domain allocation configuration

In some examples, the SBFD configuration may indicate that communications are restricted to SBFD symbols only or to non-SBFD symbols only (e.g., the UE 904 may be configured with Configuration 1), and a first reception occasion associated with the multiple PDSCH communications may include one or more SBFD symbols. In some such examples, the UE 904 may be configured not to expect a given PDSCH communication, of the multiple PDSCH communications, to be scheduled such that the given PDSCH communication overlaps with a non-SBFD symbol. That is, in some examples, if the UE 904 is configured with Configuration 1, for multiple PDSCH communications scheduled by a single DCI (e.g., DCI format 1_1) and (1) the UE 904 is configured with a time domain allocation configuration in which one or more rows include multiple SLIVs for PDSCH on a downlink BWP of a serving cell and (2) a first reception occasion includes SBFD symbols, then the UE 904 may be configured not to expect to be scheduled with one or more PDSCH communications that overlap with non-SBFD symbols (e.g., downlink symbols, uplink symbols, or flexible symbols). If the UE 904 does not expect a PDSCH communication to be scheduled that overlaps with a non-SBFD symbol, the UE 904 may not receive such a PDSCH communication, may drop such a PDSCH communication, or may not receive any PDSCH communications scheduled by a DCI communication that schedules such a PDSCH communication (e.g., may treat this as an error case).

In some examples, the SBFD configuration may indicate that communications are restricted to SBFD symbols only or to non-SBFD symbols only, and a first reception occasion associated with the multiple PDSCH communications may include one or more non-SBFD symbols. In some such examples, the UE 904 may be configured not to expect a given PDSCH communication, of the multiple PDSCH communications, to be scheduled such that the given PDSCH communication overlaps with any SBFD symbol or any uplink symbol. That is, in some examples, if the UE 904 is configured with Configuration 1, for multiple PDSCH communications scheduled by a single DCI (e.g., DCI format 1_1) and when (1) the UE 904 is configured with a time domain allocation configuration in which one or more rows include multiple SLIVs for PDSCH on a downlink BWP of a serving cell and (2) a first reception occasion includes non-SBFD symbols, then the UE 904 may be configured not to expect to be scheduled with one or more PDSCH communications that overlap with SBFD symbols or uplink symbols. If the UE 904 does not expect a PDSCH communication to be scheduled that overlaps with SBFD symbols or uplink symbols, the UE 904 may not receive such a PDSCH communication, may drop such a PDSCH communication, or may not receive any PDSCH communications scheduled by a DCI communication that schedules such a PDSCH communication (e.g., may treat this as an error case).

In some examples, the SBFD configuration may indicate that communications are permitted in both SBFD symbols and non-SBFD symbols. In some such examples, the UE 904 may be configured not to expect a given PDSCH communication, of the multiple PDSCH communications, to be scheduled such that the given PDSCH communication overlaps with an uplink symbol. That is, in some examples, if the UE 904 is configured with Configuration 2, for multiple PDSCH communications scheduled by a single DCI (e.g., DCI format 1_1) and the UE 904 is configured with a time domain allocation configuration in which one or more rows include multiple SLIVs for PDSCH on a downlink BWP of a serving cell, then the UE 904 may be configured not to expect to be scheduled with one or more PDSCH communications that overlap with uplink symbols. If the UE 904 does not expect a PDSCH communication to be scheduled that overlaps with an uplink symbol, the UE 904 may not receive such a PDSCH communication, may drop such a PDSCH communication, or may not receive any PDSCH communications scheduled by a DCI communication that schedules such a PDSCH communication (e.g., may treat this as an error case).

Note that the process flow illustrated in FIG. 9 is an example of multiple PDSCH communications in SBFD, and aspects of the present disclosure may be applied to multiple PDSCH communications in SBFD. Note that the process flow illustrated in FIG. 9 is described herein to facilitate an understanding of multiple PDSCH communications in SBFD, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations of a User Equipment

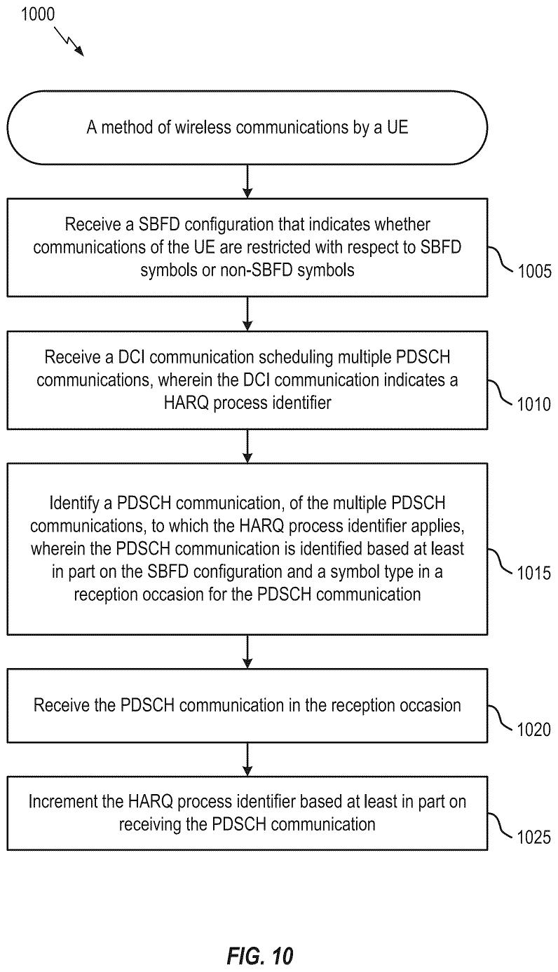

FIG. 10 shows a method 1000 for wireless communications by a UE, such as UE 104 of FIG. 1 or UE 304 of FIG. 3.

Method 1000 begins at block 1005 with receiving an SBFD configuration that indicates whether communications of the UE are restricted with respect to SBFD symbols or non-SBFD symbols. For example, the UE 804 may receive an SBFD configuration that indicates whether communications of the UE 804 are restricted with respect to SBFD symbols or non-SBFD symbols, as depicted and described with respect to reference 806 of FIG. 8.

Method 1000 then proceeds to block 1010 with receiving a DCI communication scheduling multiple PDSCH communications, wherein the DCI communication indicates a HARQ process identifier. For example, the UE 804 may receive a DCI communication scheduling multiple PDSCH communications, where the DCI communication indicates a HARQ process ID, as depicted and described with respect to reference 808 of FIG. 8.

Method 1000 then proceeds to block 1015 with identifying a PDSCH communication, of the multiple PDSCH communications, to which the HARQ process identifier applies, wherein the PDSCH communication is identified based at least in part on the SBFD configuration and a symbol type in a reception occasion for the PDSCH communication. For example, the UE 804 may identify a PDSCH communication, of the multiple PDSCH communications, to which the HARQ process identifier applies, as depicted and described with respect to reference 810 of FIG. 8.

Method 1000 then proceeds to block 1020 with receiving the PDSCH communication in the reception occasion. For example, the UE 804 may receive the PDSCH communication in the reception occasion, as depicted and described with respect to reference 812 of FIG. 8.

Method 1000 then proceeds to block 1025 with incrementing the HARQ process identifier based at least in part on receiving the PDSCH communication. For example, the UE 804 may increment the HARQ process ID, as depicted and described with respect to reference 814 of FIG. 8. In some aspects, incrementing the HARQ process ID may be optional (e.g., if no other PDSCH communication scheduled by the DCI communication will be received, then the UE may only transmit feedback information corresponding to the received PDSCH communication, and may not increment the HARQ process ID for the unreceived PDSCH communication(s).

In some aspects, the SBFD configuration indicates that communications are restricted to SBFD symbols only or to non-SBFD symbols only.

In some aspects, a first reception occasion, associated with the multiple PDSCH communications, includes one or more SBFD symbols, wherein block 1015 includes identifying the PDSCH communication as a first PDSCH communication, of the multiple PDSCH communications, for which a reception occasion includes SBFD symbols.

In some aspects, a first reception occasion, associated with the multiple PDSCH communications, includes one or more SBFD symbols, wherein block 1015 includes identifying the PDSCH communication as a first PDSCH communication, of the multiple PDSCH communications, for which a reception occasion does not overlap with any non-SBFD symbol.

In some aspects, method 1000 further includes refraining from incrementing the HARQ process identifier with respect to another PDSCH communication of the multiple PDSCH communications, wherein a reception occasion for the other PDSCH communication includes one or more non-SBFD symbols, and wherein a first reception occasion, associated with the multiple PDSCH communications, includes one or more SBFD symbols.

In some aspects, method 1000 further includes refraining from incrementing the HARQ process identifier with respect to another PDSCH communication, of the multiple PDSCH communications, based at least in part on a TDRA associated with the other PDSCH communication including at least one non-SBFD symbol, wherein a first reception occasion, associated with the multiple PDSCH communications, includes one or more SBFD symbols.

In some aspects, a first reception occasion associated with the multiple PDSCH communications includes one or more non-SBFD symbols, wherein block 1015 includes identifying the PDSCH communication as a first PDSCH communication, of the multiple PDSCH communications, for which a reception occasion includes one or more downlink symbols or one or more flexible symbols.

In some aspects, a first reception occasion associated with the multiple PDSCH communications comprises one or more non-SBFD symbols, wherein block 1015 includes identifying the PDSCH communication as a first PDSCH communication, of the multiple PDSCH communications, for which a reception occasion does not overlap with any uplink symbol or any SBFD symbol.

In some aspects, method 1000 further includes refraining from incrementing the HARQ process identifier with respect to another PDSCH communication of the multiple PDSCH communications, wherein a reception occasion for the other PDSCH communication includes one or more SBFD symbols, and wherein a first reception occasion, associated with the multiple PDSCH communications, includes one or more non-SBFD symbols.

In some aspects, method 1000 further includes refraining from incrementing the HARQ process identifier with respect to another PDSCH communication, of the multiple PDSCH communications, based at least in part on a TDRA associated with the other PDSCH communication including at least one SBFD symbol or at least one uplink symbol, wherein a first reception occasion, associated with the multiple PDSCH communications, includes one or more non-SBFD symbols.

In some aspects, the SBFD configuration indicates that communications are permitted in both SBFD symbols and non-SBFD symbols.

In some aspects, block 1015 includes identifying the PDSCH communication as a first PDSCH communication, of the multiple PDSCH communications, for which a reception occasion includes a downlink symbol or a flexible symbol.

In some aspects, block 1015 includes identifying the PDSCH communication as a first PDSCH communication, of the multiple PDSCH communications, for which a reception occasion includes an SBFD symbol.

In some aspects, block 1015 includes identifying the PDSCH communication as a first PDSCH communication, of the multiple PDSCH communications, for which a reception occasion does not overlap with any uplink symbol.

In some aspects, method 1000 further includes refraining from incrementing the HARQ process identifier with respect to another PDSCH communication, of the multiple PDSCH communications, based at least in part a TDRA associated with the other PDSCH communication including at least one uplink symbol.

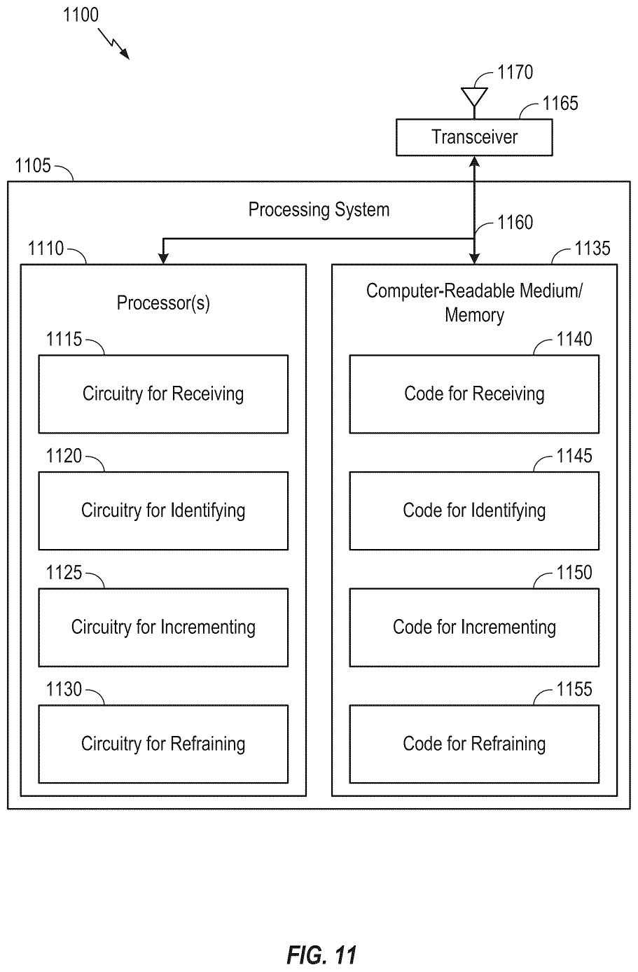

In some aspects, method 1000, or any aspect related to it, may be performed by an apparatus, such as communications device 1100 of FIG. 11, which includes various components operable, configured, or adapted to perform the method 1000. Communications device 1100 is described below in further detail.

In some aspects, the techniques for multiple PDSCH communications in SBFD described with respect to the method 1000 may enable improved wireless communications performance, such as increased reliability with respect to HARQ process ID incrementing, communication of multiple PDSCH communications scheduled by a single DCI having a particular format (e.g., format 1_1), or, more generally, PDSCH communications scheduled using a single DCI in the context of SBFD operation. This improved wireless communication performance may be attributable to the techniques and apparatuses described with respect to the method 1000, for example, due to providing consideration of whether a given UE is configured with Configuration 1 or Configuration 2 for SBFD communications across different slots with respect to UE procedures associated with multiple PDSCH communications scheduled by a single DCI.

Note that FIG. 10 is just one example of a method, and other methods including fewer, additional, or alternative operations are possible consistent with this disclosure.

### Example Communications Device

FIG. 11 depicts aspects of an example communications device 1100 configured for wireless communications. In some aspects, communications device 1100 is a user equipment, such as UE 104 described above with respect to FIG. 1 or UE 304 described with respect to FIG. 3.

The communications device 1100 includes a processing system 1105 coupled to a transceiver 1165 (e.g., a transmitter and/or a receiver). The transceiver 1165 is configured to transmit and receive signals for the communications device 1100 via an antenna 1170, such as the various signals as described herein. The processing system 1105 may be configured to perform processing functions for the communications device 1100, including processing signals received and/or to be transmitted by the communications device 1100.

The processing system 1105 includes one or more processors 1110 and a computer-readable medium/memory 1135. In various aspects, the one or more processors 1110 may be representative of the one or more processors 318 described with respect to FIG. 3. The one or more processors 1110 are coupled to a computer-readable medium/memory 1135 via a bus 1160. In some aspects, the computer-readable medium/memory 1135 may be representative of the one or more memories 320 described with respect to FIG. 3. The computer-readable medium/memory 1135 is a non-transitory computer-readable medium/memory. In certain aspects, the computer-readable medium/memory 1135 is configured to store instructions (e.g., computer-executable code), that when executed by the one or more processors 1110, cause the one or more processors 1110 to perform the method 1000 described with respect to FIG. 10, or any aspect related to it, including any operations described in relation to FIG. 10. Note that reference to a processor performing a function of communications device 1100 may include one or more processors performing that function of communications device 1100, such as in a distributed fashion.

In the depicted example, computer-readable medium/memory 1135 stores code (e.g., executable instructions), including code for receiving 1140, code for identifying 1145, code for incrementing 1150, and code for refraining 1155. Processing of the code 1140-1155 may enable and cause the communications device 1100 to perform the method 1000 described with respect to FIG. 10, or any aspect related to it. For instance, in some aspects, code for receiving 1140 includes code for receiving an SBFD configuration that indicates whether communications of the UE are restricted with respect to SBFD symbols or non-SBFD symbols. In some aspects, code for receiving 1140 includes code for receiving a DCI communication scheduling multiple PDSCH communications, wherein the DCI communication indicates a HARQ process identifier. In some aspects, code for identifying 1145 includes code for identifying a PDSCH communication, of the multiple PDSCH communications, to which the HARQ process identifier applies, wherein the PDSCH communication is identified based at least in part on the SBFD configuration and a symbol type in a reception occasion for the PDSCH communication. In some aspects, code for receiving 1140 includes code for receiving the PDSCH communication in the reception occasion. In some aspects, code for incrementing 1150 includes code for incrementing the HARQ process identifier based at least in part on receiving the PDSCH communication.

The one or more processors 1110 include circuitry configured to implement (e.g., execute) the code stored in the computer-readable medium/memory 1135, including circuitry for receiving 1115, circuitry for identifying 1120, circuitry for incrementing 1125, and circuitry for refraining 1130. Processing with circuitry 1115-1130 may enable and cause the communications device 1100 to perform the method 1000 described with respect to FIG. 10, or any aspect related to it. For instance, in some aspects, circuitry for receiving 1115 includes circuitry for receiving an SBFD configuration that indicates whether communications of the UE are restricted with respect to SBFD symbols or non-SBFD symbols. In some aspects, circuitry for receiving 1115 includes circuitry for receiving a DCI communication scheduling multiple PDSCH communications, wherein the DCI communication indicates a HARQ process identifier. In some aspects, circuitry for identifying 1120 includes circuitry for identifying a PDSCH communication, of the multiple PDSCH communications, to which the HARQ process identifier applies, wherein the PDSCH communication is identified based at least in part on the SBFD configuration and a symbol type in a reception occasion for the PDSCH communication. In some aspects, circuitry for receiving 1115 includes circuitry for receiving the PDSCH communication in the reception occasion. In some aspects, circuitry for incrementing 1125 includes circuitry for incrementing the HARQ process identifier based at least in part on receiving the PDSCH communication.

More generally, means for communicating, transmitting, sending or outputting for transmission may include the one or more transceivers 324, one or more antenna 322 and/or processing system 316 of the UE 304 illustrated in FIG. 3, transceiver 1165 and/or antenna 1170 of the communications device 1100 in FIG. 11, and/or one or more processors 1110 of the communications device 1100 in FIG. 11. Means for communicating, receiving or obtaining may include the one or more transceivers 324, one or more antennas 322, and/or processing system 316 of the UE 304 illustrated in FIG. 3, transceiver 1165 and/or antenna 1170 of the communications device 1100 in FIG. 11, and/or one or more processors 1110 of the communications device 1100 in FIG. 11.

### Example Operations of a User Equipment

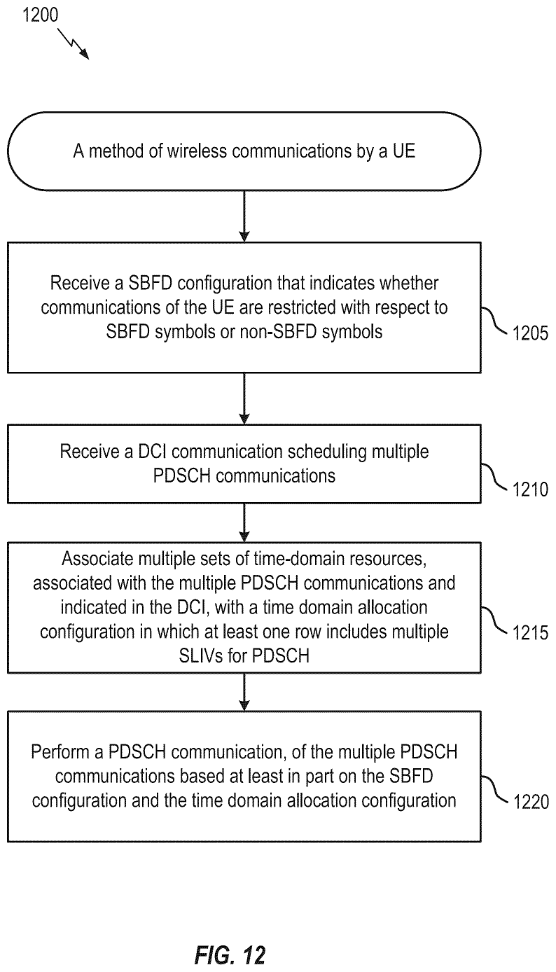

FIG. 12 shows a method 1200 for wireless communications by a UE, such as UE 104 of FIG. 1 or UE 304 of FIG. 3.

Method 1200 begins at block 1205 with receiving an SBFD configuration that indicates whether communications of the UE are restricted with respect to SBFD symbols or non-SBFD symbols. For example, a UE 904 may receive an SBFD configuration that indicates whether communications of the UE 904 are restricted with respect to SBFD symbols or non-SBFD symbols, as depicted and described with respect to reference 906 of FIG. 9.

Method 1200 then proceeds to block 1210 with receiving a DCI communication scheduling multiple PDSCH communications. For example, the UE 904 may receive a DCI communication scheduling multiple PDSCH communications, as depicted and described with respect to reference 908 of FIG. 9.

Method 1200 then proceeds to block 1215 with associating multiple sets of time-domain resources, associated with the multiple PDSCH communications and indicated in the DCI, with a time domain allocation configuration in which at least one row includes multiple SLIVs for PDSCH. For example, the UE 904 may associate multiple sets of time-domain resources, associated with the multiple PDSCH communications and indicated in the DCI, with a time domain allocation configuration in which at least on row includes multiple SLIVs for PDSCH, as depicted and described with respect to reference 910 of FIG. 9.

Method 1200 then proceeds to block 1220 with performing a PDSCH communication, of the multiple PDSCH communications, based at least in part on the SBFD configuration and the time domain allocation configuration. For example, the UE 904 may perform a PDSCH communication, as depicted and described with respect to reference 912 of FIG. 9.

In some aspects, a format of the DCI communication is a non-fallback downlink scheduling DCI format for one cell.

In some aspects, the SBFD configuration indicates that communications are restricted to SBFD symbols only or to non-SBFD symbols only.

In some aspects, a first reception occasion associated with the multiple PDSCH communications comprises one or more SBFD symbols, wherein the UE is configured not to expect a given PDSCH communication, of the multiple PDSCH communications, to be scheduled such that the given PDSCH communication overlaps with a non-SBFD symbol.

In some aspects, a first reception occasion associated with the multiple PDSCH communications comprises one or more non-SBFD symbols, wherein the UE is configured not to expect a given PDSCH communication, of the multiple PDSCH communications, to be scheduled such that the given PDSCH communication overlaps with any SBFD symbol or with any uplink symbol.

In some aspects, the SBFD configuration indicates that communications are permitted in SBFD symbols or non-SBFD symbols.

In some aspects, the UE is configured not to expect a given PDSCH communication, of the multiple PDSCH communications, to be scheduled such that the given PDSCH communication overlaps with an uplink symbol.

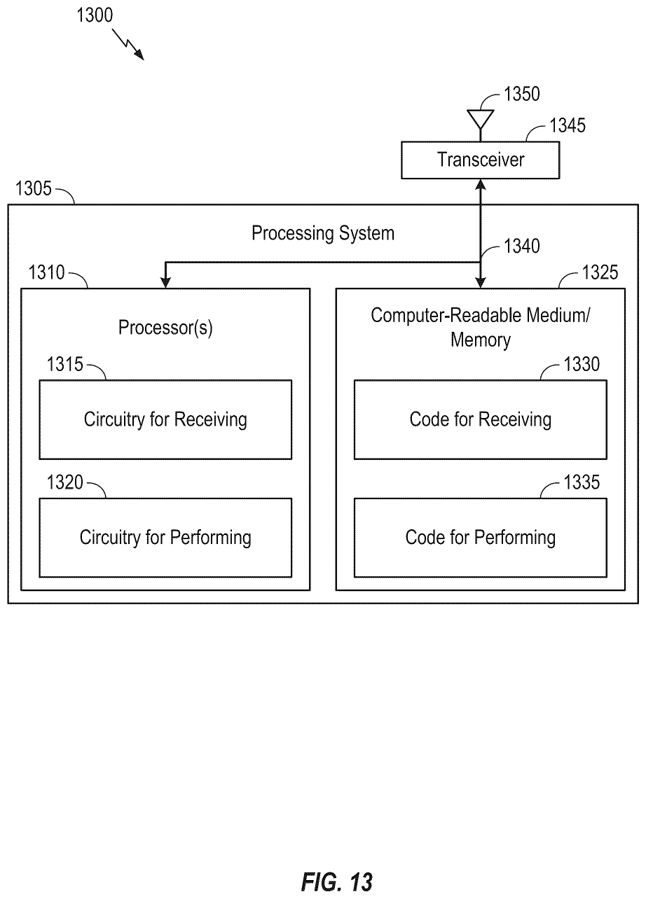

In some aspects, method 1200, or any aspect related to it, may be performed by an apparatus, such as communications device 1300 of FIG. 13, which includes various components operable, configured, or adapted to perform the method 1200. Communications device 1300 is described below in further detail.

In some aspects, the techniques for multiple PDSCH communications in SBFD described with respect to the method 1200 may enable improved wireless communications performance, such as increased reliability with respect to HARQ process ID incrementing, communication of multiple PDSCH communications scheduled by a single DCI having a particular format (e.g., format 1_1), or, more generally, PDSCH communications scheduled using a single DCI in the context of SBFD operation. This improved wireless communication performance may be attributable to the techniques and apparatuses described with respect to the method 1200, for example, due to providing consideration of whether a given UE is configured with Configuration 1 or Configuration 2 for SBFD communications across different slots with respect to UE procedures associated with multiple PDSCH communications scheduled by a single DCI.

Note that FIG. 12 is just one example of a method, and other methods including fewer, additional, or alternative operations are possible consistent with this disclosure.

### Example Communications Device

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3.

The communications device 1300 includes a processing system 1305 coupled to a transceiver 1345 (e.g., a transmitter and/or a receiver). The transceiver 1345 is configured to transmit and receive signals for the communications device 1300 via an antenna 1350, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1325. In various aspects, the one or more processors 1310 may be representative of the one or more processors 318 described with respect to FIG. 3. The one or more processors 1310 are coupled to a computer-readable medium/memory 1325 via a bus 1340. In some aspects, the computer-readable medium/memory 1325 may be representative of the one or more memories 320 described with respect to FIG. 3. The computer-readable medium/memory 1325 is a non-transitory computer-readable medium/memory. In certain aspects, the computer-readable medium/memory 1325 is configured to store instructions (e.g., computer-executable code), that when executed by the one or more processors 1310, cause the one or more processors 1310 to perform the method 1200 described with respect to FIG. 12, or any aspect related to it, including any operations described in relation to FIG. 12. Note that reference to a processor performing a function of communications device 1300 may include one or more processors performing that function of communications device 1300, such as in a distributed fashion.

In the depicted example, computer-readable medium/memory 1325 stores code (e.g., executable instructions), including code for receiving 1330 and code for performing 1335. Processing of the code 1330 and 1335 may enable and cause the communications device 1300 to perform the method 1200 described with respect to FIG. 12, or any aspect related to it. For instance, in some aspects, code for receiving 1330 includes code for receiving an SBFD configuration that indicates whether communications of the UE are restricted with respect to SBFD symbols or non-SBFD symbols. In some aspects, code for receiving 1330 includes code for receiving a DCI communication scheduling multiple PDSCH communications. In some aspects, code for receiving 1330 includes code for associating multiple sets of time-domain resources, associated with the multiple PDSCH communications and indicated in the DCI, with a time domain allocation configuration in which at least one row includes multiple SLIVs for PDSCH. In some aspects, code for performing 1335 includes code for performing a PDSCH communication, of the multiple PDSCH communications based at least in part on the SBFD configuration and the time domain allocation configuration.

The one or more processors 1310 include circuitry configured to implement (e.g., execute) the code stored in the computer-readable medium/memory 1325, including circuitry for receiving 1315 and circuitry for performing 1320. Processing with circuitry 1315 and 1320 may enable and cause the communications device 1300 to perform the method 1200 described with respect to FIG. 12, or any aspect related to it. For instance, in some aspects, circuitry for receiving 1315 includes circuitry for receiving an SBFD configuration that indicates whether communications of the UE are restricted with respect to SBFD symbols or non-SBFD symbols. In some aspects, circuitry for receiving 1315 includes circuitry for receiving a DCI communication scheduling multiple PDSCH communications. In some aspects, circuitry for receiving 1315 includes circuitry for associating multiple sets of time-domain resources, associated with the multiple PDSCH communications and indicated in the DCI, with a time domain allocation configuration in which at least one row includes multiple SLIVs for PDSCH. In some aspects, circuitry for performing 1320 includes circuitry for performing a PDSCH communication, of the multiple PDSCH communications based at least in part on the SBFD configuration and the time domain allocation configuration.

More generally, means for communicating, transmitting, sending or outputting for transmission may include the one or more transceivers 324, one or more antenna 322 and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13.

### EXAMPLE CLAUSES

Implementation examples are described in the following numbered clauses:

Clause 1: A method of wireless communications by a UE, comprising: receiving an SBFD configuration that indicates whether communications of the UE are restricted with respect to SBFD symbols or non-SBFD symbols; receiving a DCI communication scheduling multiple PDSCH communications, wherein the DCI communication indicates a HARQ process identifier; identifying a PDSCH communication, of the multiple PDSCH communications, to which the HARQ process identifier applies, wherein the PDSCH communication is identified based at least in part on the SBFD configuration and a symbol type in a reception occasion for the PDSCH communication; receiving the PDSCH communication in the reception occasion; and incrementing the HARQ process identifier based at least in part on receiving the PDSCH communication.

Clause 2: The method of Clause 1, wherein the SBFD configuration indicates that communications are restricted to SBFD symbols only or to non-SBFD symbols only.

Clause 3: The method of Clause 2, wherein a first reception occasion, associated with the multiple PDSCH communications, includes one or more SBFD symbols, wherein identifying the PDSCH communication to which the HARQ process identifier applies comprises identifying the PDSCH communication as a first PDSCH communication, of the multiple PDSCH communications, for which a reception occasion includes SBFD symbols.

Clause 4: The method of Clause 2, wherein a first reception occasion, associated with the multiple PDSCH communications, includes one or more SBFD symbols, wherein identifying the PDSCH communication comprises identifying the PDSCH communication as a first PDSCH communication, of the multiple PDSCH communications, for which a reception occasion does not overlap with any non-SBFD symbol.

Clause 5: The method of Clause 2, further comprising: refraining from incrementing the HARQ process identifier with respect to another PDSCH communication of the multiple PDSCH communications, wherein a reception occasion for the other PDSCH communication includes one or more non-SBFD symbols, and wherein a first reception occasion, associated with the multiple PDSCH communications, includes one or more SBFD symbols.

Clause 6: The method of Clause 2, further comprising: refraining from incrementing the HARQ process identifier with respect to another PDSCH communication, of the multiple PDSCH communications, based at least in part on a TDRA associated with the other PDSCH communication including at least one non-SBFD symbol, wherein a first reception occasion, associated with the multiple PDSCH communications, includes one or more SBFD symbols.

Clause 7: The method of Clause 2, wherein a first reception occasion associated with the multiple PDSCH communications includes one or more non-SBFD symbols, wherein identifying the PDSCH communication comprises identifying the PDSCH communication as a first PDSCH communication, of the multiple PDSCH communications, for which a reception occasion includes one or more downlink symbols or one or more flexible symbols.

Clause 8: The method of Clause 2, wherein a first reception occasion associated with the multiple PDSCH communications comprises one or more non-SBFD symbols, wherein identifying the PDSCH communication comprises identifying the PDSCH communication as a first PDSCH communication, of the multiple PDSCH communications, for which a reception occasion does not overlap with any uplink symbol or any SBFD symbol.

Clause 9: The method of Clause 2, further comprising: refraining from incrementing the HARQ process identifier with respect to another PDSCH communication of the multiple PDSCH communications, wherein a reception occasion for the other PDSCH communication includes one or more SBFD symbols, and wherein a first reception occasion, associated with the multiple PDSCH communications, includes one or more non-SBFD symbols.

Clause 10: The method of Clause 2, further comprising: refraining from incrementing the HARQ process identifier with respect to another PDSCH communication, of the multiple PDSCH communications, based at least in part on a TDRA associated with the other PDSCH communication including at least one SBFD symbol or at least one uplink symbol, wherein a first reception occasion, associated with the multiple PDSCH communications, includes one or more non-SBFD symbols.

Clause 11: The method of any one of Clauses 1-10, wherein the SBFD configuration indicates that communications are permitted in both SBFD symbols and non-SBFD symbols.

Clause 12: The method of Clause 11, wherein identifying the PDSCH communication to which the HARQ process identifier applies comprises identifying the PDSCH communication as a first PDSCH communication, of the multiple PDSCH communications, for which a reception occasion includes a downlink symbol or a flexible symbol.

Clause 13: The method of Clause 11, wherein identifying the PDSCH communication comprises identifying the PDSCH communication as a first PDSCH communication, of the multiple PDSCH communications, for which a reception occasion includes an SBFD symbol.

Clause 14: The method of Clause 11, wherein identifying the PDSCH communication comprises identifying the PDSCH communication as a first PDSCH communication, of the multiple PDSCH communications, for which a reception occasion does not overlap with any uplink symbol.

Clause 15: The method of Clause 11, further comprising: refraining from incrementing the HARQ process identifier with respect to another PDSCH communication, of the multiple PDSCH communications, based at least in part a TDRA associated with the other PDSCH communication including at least one uplink symbol.

Clause 16: A method of wireless communications by a UE, comprising: receiving an SBFD configuration that indicates whether communications of the UE are restricted with respect to SBFD symbols or non-SBFD symbols; receiving a DCI communication scheduling multiple PDSCH communications; associating multiple sets of time-domain resources, associated with the multiple PDSCH communications and indicated in the DCI, with a time domain allocation configuration in which at least one row includes multiple SLIVs for PDSCH; and performing a PDSCH communication, of the multiple PDSCH communications based at least in part on the SBFD configuration and the time domain allocation configuration.

Clause 17: The method of Clause 16, wherein a format of the DCI communication is a non-fallback downlink scheduling DCI format for one cell.

Clause 18: The method of any one of Clauses 16-17, wherein the SBFD configuration indicates that communications are restricted to SBFD symbols only or to non-SBFD symbols only.

Clause 19: The method of Clause 18, wherein a first reception occasion associated with the multiple PDSCH communications comprises one or more SBFD symbols, wherein the UE is configured not to expect a given PDSCH communication, of the multiple PDSCH communications, to be scheduled such that the given PDSCH communication overlaps with a non-SBFD symbol.

Clause 20: The method of Clause 18, wherein a first reception occasion associated with the multiple PDSCH communications comprises one or more non-SBFD symbols, wherein the UE is configured not to expect a given PDSCH communication, of the multiple PDSCH communications, to be scheduled such that the given PDSCH communication overlaps with any SBFD symbol or with any uplink symbol.

Clause 21: The method of any one of Clauses 16-20, wherein the SBFD configuration indicates that communications are permitted in SBFD symbols or non-SBFD symbols.

Clause 22: The method of Clause 21, wherein the UE is configured not to expect a given PDSCH communication, of the multiple PDSCH communications, to be scheduled such that the given PDSCH communication overlaps with an uplink symbol.

Clause 23: One or more apparatuses, comprising: one or more memories comprising executable instructions; and one or more processors configured to execute the executable instructions and cause the one or more apparatuses to perform a method in accordance with any one of Clauses 1-22.

Clause 24: One or more apparatuses configured for wireless communications, comprising: one or more memories; and one or more processors, coupled to the one or more memories, configured to cause the one or more apparatuses to perform a method in accordance with any one of Clauses 1-22.

Clause 25: One or more apparatuses configured for wireless communications, comprising: one or more memories; and one or more processors, coupled to the one or more memories, configured to perform a method in accordance with any one of Clauses 1-22.

Clause 26: One or more apparatuses, comprising means for performing a method in accordance with any one of Clauses 1-22.

Clause 27: One or more non-transitory computer-readable media comprising executable instructions that, when executed by one or more processors of one or more apparatuses, cause the one or more apparatuses to perform a method in accordance with any one of Clauses 1-22.

Clause 28: One or more computer program products embodied on one or more computer-readable storage media comprising code for performing a method in accordance with any one of Clauses 1-22.

Clause 29: One or more apparatuses configured for wireless communications, comprising: a processing system that includes one or more processors and one or more memories coupled with the one or more processors, the processing system configured to cause the one or more apparatuses to perform a method in accordance with any one of Clauses 1-22.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communication, comprising a processing system that includes one or more processors and one or more memories coupled with the one or more processors, the processing system configured to cause a user equipment (UE) to:
receive a subband full-duplex (SBFD) configuration that indicates whether communications of the UE are restricted with respect to SBFD symbols or non-SBFD symbols;
receive a downlink control information (DCI) communication scheduling multiple physical downlink shared channel (PDSCH) communications,
wherein the DCI communication indicates a hybrid automatic repeat request (HARQ) process identifier;
identify a PDSCH communication, of the multiple PDSCH communications, to which the HARQ process identifier applies,
wherein the PDSCH communication is identified based at least in part on the SBFD configuration and a symbol type in a reception occasion for the PDSCH communication;
receive the PDSCH communication in the reception occasion; and
increment the HARQ process identifier based at least in part on receiving the PDSCH communication.

2. The apparatus of claim 1, wherein the SBFD configuration indicates that communications are restricted to SBFD symbols only or to non-SBFD symbols only.

3. The apparatus of claim 2, wherein a first reception occasion, associated with the multiple PDSCH communications, includes one or more SBFD symbols,
wherein to cause the UE to identify the PDSCH communication to which the HARQ process identifier applies, the processing system is configured to cause the UE to identify the PDSCH communication as a first PDSCH communication, of the multiple PDSCH communications, for which a reception occasion includes SBFD symbols.

4. The apparatus of claim 2, wherein a first reception occasion, associated with the multiple PDSCH communications, includes one or more SBFD symbols,
wherein to cause the UE to identify the PDSCH communication, the processing system is configured to cause the UE to identify the PDSCH communication as a first PDSCH communication, of the multiple PDSCH communications, for which a reception occasion does not overlap with any non-SBFD symbol.

5. The apparatus of claim 2, wherein the processing system is further configured to cause the UE to:
refrain from incrementing the HARQ process identifier with respect to another PDSCH communication of the multiple PDSCH communications,
wherein a reception occasion for the other PDSCH communication includes one or more non-SBFD symbols, and
wherein a first reception occasion, associated with the multiple PDSCH communications, includes one or more SBFD symbols.

6. The apparatus of claim 2, wherein the processing system is further configured to cause the UE to:
refrain from incrementing the HARQ process identifier with respect to another PDSCH communication, of the multiple PDSCH communications, based at least in part on a time domain resource allocation (TDRA) associated with the other PDSCH communication including at least one non-SBFD symbol,
wherein a first reception occasion, associated with the multiple PDSCH communications, includes one or more SBFD symbols.

7. The apparatus of claim 2, wherein a first reception occasion associated with the multiple PDSCH communications includes one or more non-SBFD symbols,
wherein to cause the UE to identify the PDSCH communication, the processing system is configured to cause the UE to identify the PDSCH communication as a first PDSCH communication, of the multiple PDSCH communications, for which a reception occasion includes one or more downlink symbols or one or more flexible symbols.

8. The apparatus of claim 2, wherein a first reception occasion associated with the multiple PDSCH communications comprises one or more non-SBFD symbols,
wherein to cause the UE to identify the PDSCH communication, the processing system is configured to cause the UE to identify the PDSCH communication as a first PDSCH communication, of the multiple PDSCH communications, for which a reception occasion does not overlap with any uplink symbol or any SBFD symbol.

9. The apparatus of claim 2, wherein the processing system is further configured to cause the UE to:
refrain from incrementing the HARQ process identifier with respect to another PDSCH communication of the multiple PDSCH communications,
wherein a reception occasion for the other PDSCH communication includes one or more SBFD symbols, and
wherein a first reception occasion, associated with the multiple PDSCH communications, includes one or more non-SBFD symbols.

10. The apparatus of claim 2, wherein the processing system is further configured to cause the UE to:
refrain from incrementing the HARQ process identifier with respect to another PDSCH communication, of the multiple PDSCH communications, based at least in part on a time domain resource allocation (TDRA) associated with the other PDSCH communication including at least one SBFD symbol or at least one uplink symbol,
wherein a first reception occasion, associated with the multiple PDSCH communications, includes one or more non-SBFD symbols.

11. The apparatus of claim 1, wherein the SBFD configuration indicates that communications are permitted in both SBFD symbols and non-SBFD symbols.

12. The apparatus of claim 11, wherein to cause the UE to identify the PDSCH communication to which the HARQ process identifier applies, the processing system is configured to cause the UE to identify the PDSCH communication as a first PDSCH communication, of the multiple PDSCH communications, for which a reception occasion includes a downlink symbol or a flexible symbol.

13. The apparatus of claim 11, wherein to cause the UE to identify the PDSCH communication, the processing system is configured to cause the UE to identify the PDSCH communication as a first PDSCH communication, of the multiple PDSCH communications, for which a reception occasion includes an SBFD symbol.

14. The apparatus of claim 11, wherein to cause the UE to identify the PDSCH communication, the processing system is configured to cause the UE to identify the PDSCH communication as a first PDSCH communication, of the multiple PDSCH communications, for which a reception occasion does not overlap with any uplink symbol.

15. The apparatus of claim 11, wherein the processing system is further configured to cause the UE to:
refrain from incrementing the HARQ process identifier with respect to another PDSCH communication, of the multiple PDSCH communications, based at least in part a time domain resource allocation (TDRA) associated with the other PDSCH communication including at least one uplink symbol.

16. A method of wireless communications by a user equipment (UE), comprising:
receiving a subband full-duplex (SBFD) configuration that indicates whether communications of the UE are restricted with respect to SBFD symbols or non-SBFD symbols;
receiving a downlink control information (DCI) communication scheduling multiple physical downlink shared channel (PDSCH) communications,
wherein the DCI communication indicates a hybrid automatic repeat request (HARQ) process identifier;
identifying a PDSCH communication, of the multiple PDSCH communications, to which the HARQ process identifier applies,
wherein the PDSCH communication is identified based at least in part on the SBFD configuration and a symbol type in a reception occasion for the PDSCH communication;
receiving the PDSCH communication in the reception occasion; and
incrementing the HARQ process identifier based at least in part on receiving the PDSCH communication.

17. The method of claim 16, wherein the SBFD configuration indicates that communications are restricted to SBFD symbols only or to non-SBFD symbols only.

18. The method of claim 17, wherein a first reception occasion, associated with the multiple PDSCH communications, includes one or more SBFD symbols,
wherein identifying the PDSCH communication to which the HARQ process identifier applies comprises identifying the PDSCH communication as a first PDSCH communication, of the multiple PDSCH communications, for which a reception occasion includes SBFD symbols.

19. The method of claim 16, wherein the SBFD configuration indicates that communications are permitted in both SBFD symbols and non-SBFD symbols.

20. An apparatus for wireless communications comprising:
means for receiving a subband full-duplex (SBFD) configuration that indicates whether communications of the apparatus are restricted with respect to SBFD symbols or non-SBFD symbols;
means for receiving a downlink control information (DCI) communication scheduling multiple physical downlink shared channel (PDSCH) communications,
wherein the DCI communication indicates a hybrid automatic repeat request (HARQ) process identifier;
means for identifying a PDSCH communication, of the multiple PDSCH communications, to which the HARQ process identifier applies,
wherein the PDSCH communication is identified based at least in part on the SBFD configuration and a symbol type in a reception occasion for the PDSCH communication;
means for receiving the PDSCH communication in the reception occasion; and
means for incrementing the HARQ process identifier based at least in part on receiving the PDSCH communication.
